(19) United States
(12) Patent Application Publication
(10) Pub. No.: US 2025/0134082 A1
(43) Pub. Date: May 1, 2025

(54) MODULAR AND ADJUSTABLE FISHING ROD HOLDER SYSTEM WITH ENHANCED GRIPPING AND STABILITY MECHANISMS

(71) Applicant: Tackle JAK, Lumberton, NJ (US)

(72) Inventor: Jeffrey Alan Kremper, Lumberton, NJ (US)

(73) Assignee: Tackle JAK, Lumberton, NJ (US)

(21) Appl. No.: 19/010,317

(22) Filed: Jan. 6, 2025

Related U.S. Application Data
(63) Continuation-in-part of application No. 17/938,166, filed on Oct. 5, 2022, now Pat. No. 12,219,946.

(51) Int. Cl. A01K 97/10

(52) U.S. Cl. CPC A01K 97/10

(57) ABSTRACT

A fishing rod holder system designed for secure and adaptable attachment to fishing rods, offering enhanced functionality and stability during use. The system includes a rod holder with a stake half and a support half, configured to attach around a fishing rod handle. The stake half features a stake retaining compartment, an adjustment slot, and a stake with a stake attachment hole, allowing the stake to slide for storage or extension. A knob or interlocking connector secures the stake in place. Optional features include grip pads, pressure ribs, grip clamps, and threaded tabs, enabling precise adjustment and compatibility with various rod sizes. The system's modular design ensures tool-free assembly, even force distribution, and resistance to slippage or damage. With robust materials and innovative features like raised ridges and rib push ridges, the holder delivers superior stability, durability, and ease of use in diverse fishing environments.

### CROSS-REFERENCE TO RELATED APPLICATIONS

This application contains subject matter which is related to the subject matter of the following co-pending application. The below-listed application is hereby incorporated herein by reference in its entirety:

This is a U.S. non-provisional application that is a continuation in part of a U.S. non-provisional application Ser. No. 17/938,166, inventor Jeffrey Alan Kremper, entitled “FISHING ROD SUPPORT STRUCTURE”, filed Oct. 5, 2022.

### TECHNICAL FIELD OF THE INVENTION

The present invention relates to fishing rod holder systems and, more particularly, to modular and adaptable fishing rod holders designed to securely attach to fishing rods, enable adjustable stake positioning for anchoring in various terrains, and provide enhanced stability and protection during use. The invention integrates features such as interlocking connectors, grip pads, pressure ribs, and flexible clamps to ensure a secure and customizable fit for fishing rods of different sizes and configurations. Additionally, the invention is directed toward fishing rod holders that facilitate tool-free assembly, precise alignment, and resistance to slippage or damage, making them suitable for diverse fishing applications and environments.

### BACKGROUND OF THE INVENTION

Before the development of our invention, fishing rod holder systems frequently faced numerous limitations that affected their practicality and efficiency. Traditional fishing rod holders often lacked the necessary adjustability and stability, leading to challenges in securing the fishing rod firmly, especially in diverse environmental conditions. These systems commonly relied on fixed designs that were not adaptable to different rod sizes or terrains, making them unsuitable for varied fishing practices.

Moreover, many existing holders required complex assembly or the use of tools, which detracted from their convenience and user-friendliness. The reliance on permanent, non-adjustable stakes limited their functionality across different types of ground, forcing anglers to carry multiple systems or adapt in less effective ways. Additionally, these systems often failed to provide secure attachment, leading to slippage and instability, which could result in damage to the fishing rod or decreased effectiveness during use.

The lack of modularity in previous designs also meant that users could not customize or upgrade their systems easily. Components such as stakes, holders, and grips were typically integrated in a manner that did not allow for replacement or adjustment based on wear or changing needs. This not only limited the lifespan of the product but also its adaptability to new fishing techniques and equipment enhancements.

Previous fishing rod holders also did not adequately address the need for protective features that could prevent damage to the rod during mounting and dismounting. The materials used often did not withstand environmental stresses well, leading to corrosion, wear, and eventual failure. The visual and functional design of these systems frequently failed to meet the aesthetic or ergonomic needs of modern anglers, which could detract from the overall fishing experience.

The present invention addresses these and other shortcomings by providing a modular and adaptable fishing rod holder system. The invention integrates features such as interlocking connectors, adjustable stakes, grip pads, and secure clamping mechanisms to ensure stability, durability, and ease of use. For these reasons and shortcomings, as well as other reasons and shortcomings, there is a long-felt need that gives rise to the present invention.

### SUMMARY OF THE INVENTION

The shortcomings of the prior art are overcome, and significant advantages are introduced through the provision of a fishing rod holder system that combines adjustability, secure attachment, and durability. This system includes a rod holder comprising a stake half and a support half, designed to attach around the handle of a fishing rod. The stake half features a stake retaining compartment along its interior surface and an adjustment slot that runs parallel to the fishing rod, facilitating precise positioning.

A stake with a stake attachment hole is configured to slide within the retaining compartment, enabling seamless retraction for storage or extension for use. A knob passes through the adjustment slot and threads into the stake attachment hole, providing an efficient locking mechanism. Loosening the knob allows the stake to slide freely, while tightening secures the stake in place, ensuring stability during use or transport. This design offers a versatile and robust solution, addressing prior limitations by enhancing adaptability, ease of use, and reliability for various fishing environments.

Additional shortcomings of the prior art are overcome, and significant advantages are introduced through the provision of a fishing rod holder system that combines secure attachment, adjustability, and enhanced grip mechanisms. This system includes a rod holder with a stake half that features one or more aligned pairs of grip clamp slots near its perimeter edges. The stake half also includes a stake retaining compartment along its interior surface and an adjustment slot running parallel to the fishing rod, allowing precise stake positioning.

A flexible grip collar with a longitudinal grip collar slot wraps around the handle of a fishing rod in a self-contouring manner, providing a secure and custom fit. One or more grip clamps pass through the aligned grip clamp slots on the stake half, attaching the rod holder firmly to the grip collar and the fishing rod handle. A stake with a stake attachment hole fits within the stake retaining compartment, enabling it to slide for retraction or extension in a controlled manner.

A knob passing through the adjustment slot threads into the stake attachment hole, providing a secure locking mechanism. Loosening the knob allows the stake to slide freely, while tightening it secures the stake in place, ensuring stability during use or storage. This innovative system addresses limitations in prior designs by offering a robust, adaptable, and user-friendly solution for diverse fishing environments.

Additional shortcomings of the prior art are overcome, and significant advantages are introduced through the provision of a fishing rod holder system designed for secure attachment, adjustability, and enhanced grip. This system includes a rod holder featuring a stake half, a support half, and multiple threaded tabs with a gap between them at each end of the rod holder. The stake half incorporates a stake retaining compartment that houses a stake configured to slide in and out along a stake slot without detachment, enabling flexible adjustment for various uses and terrains.

A rib pad positioned between the stake and the rod holder includes pressure ribs on its front side, designed to flexibly contour to and grip the handle of a fishing rod, and a rib push ridge along its back side, which facilitates even force distribution. An interlocking connector, comprising a first and second interlocking connector half with interior threads, engages the threaded tabs of the rod holder. Tightening the interlocking connector compresses the rib pad against the fishing rod handle, applying force along the rib push ridge to ensure a secure and stable attachment.

This design distinguishes itself by addressing prior limitations, such as inadequate grip and instability, with features that provide modularity, reliability, and ease of use, making it ideal for diverse fishing conditions and equipment configurations.

Additional features and advantages are realized through the techniques of the present invention. Other embodiments and aspects of the invention are described in detail herein and are considered a part of the claimed invention. For a better understanding of the invention with advantages and features, refer to the description and the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1-14 illustrates one example of a fishing rod holder system with stake-length knob adjustment;

FIGS. 15-29 illustrates one example of a fishing rod holder system with stake-length pressure ribs; and

FIGS. 30-43 illustrates one example of a fishing rod holder system with rod grip clamps adjustment.

The detailed description explains the preferred embodiments of the invention, together with advantages and features, by way of example with reference to the drawings.

### DETAILED DESCRIPTION OF THE INVENTION

The following detailed description is provided to enable those skilled in the art to make and use the invention, incorporating specific examples and configurations to illustrate its principles. The invention relates to a fishing rod holder system 100 designed to address the shortcomings of prior approaches by offering enhanced stability, modularity, adjustability, and ease of use. This system has been developed to meet the long-felt need for a reliable and versatile fishing rod holder capable of adapting to various fishing conditions and rod configurations.

The fishing rod holder system 100 integrates innovative components, including a rod holder 120/122 comprising a stake half 122 and a support half 120, an adjustable stake 114, interlocking connectors 102A/102B, and optional gripping mechanisms such as grip clamps 142 and grip pads 150. These elements work synergistically to ensure secure attachment to the handle of a fishing rod 202, precise stake positioning for anchoring in various terrains, and protection against slippage or damage during use. The design incorporates durable, corrosion-resistant materials, making the system suitable for long-term use in aquatic environments.

A critical feature of the invention is its modularity and adjustability. The stake half 122 of the rod holder 120/122 includes a stake retaining compartment 124 and, in some embodiments, an adjustment slot 138, allowing the stake 114 to slide for retraction or extension without detachment. This enables anglers to adapt the system to various terrains, ensuring stability during use. A knob 140 or interlocking connector 102A/102B provides a secure locking mechanism, preventing the stake 114 from shifting during use or transport. These components work together to deliver a robust anchoring solution that overcomes the limitations of fixed-stake or non-retractable designs.

The system includes interlocking connectors 102A/102B configured to engage threaded tabs 162 at each end of the rod holder 120/122. These interlocking connectors 102A/102B are curvilinear in shape and include interlocking halves with locking stems 104, locking grooves 106, and interlocking connector threads 108. This configuration ensures precise alignment, secure attachment, and even pressure distribution around the handle of the fishing rod 202, eliminating slippage and enhancing stability. By integrating this feature, the invention addresses the reliability issues commonly associated with friction-based or snap-fit mechanisms in prior design approaches.

Optional gripping mechanisms provide additional versatility and protection for the fishing rod 202. The rod holder 120/122 can include grip clamps 142 that secure a flexible grip collar 146 around the handle of the fishing rod. A grip pad 150 positioned between the stake half 122 and the grip collar 146 includes pressure ribs 154 and grip pad notches 156 to prevent rotational movement and slippage. These features accommodate fishing rods of varying sizes while protecting the rod handle from wear or damage, even during prolonged use or under dynamic forces.

Another innovative aspect of the invention is the compression mechanism for securing the stake 114 and the fishing rod 202. The system includes a rib pad 126 positioned between the stake 114 and the rod holder 120/122, featuring a rib push ridge 164 and a push ridge 166. A pressure pad pusher 130 with ripple ridges 168 interacts with the rib push ridge 164 to ensure consistent compression. A locking tray 132 with locking notches 134 further stabilizes the components, providing a secure and precise fit. The compression mechanism allows for easy stake repositioning without detachment, enhancing the system's usability and reliability.

The invention is further characterized by its use of robust materials such as anodized aluminum, reinforced polymers, and stainless steel, ensuring resistance to environmental factors such as moisture, salt, and UV exposure. This choice of materials enhances the system's longevity, making it suitable for recreational and professional anglers alike. By integrating these features into a cohesive design, the fishing rod holder system 100 provides a superior solution for securely anchoring fishing rods, protecting equipment, and ensuring a convenient and reliable fishing experience in diverse environments.

Fishing Rod Holder System with Stake-Length Knob Adjustment

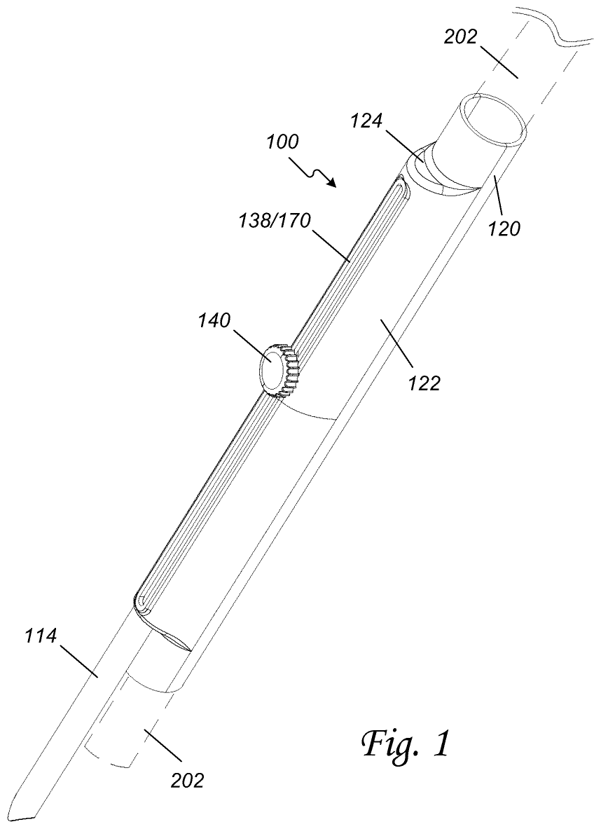

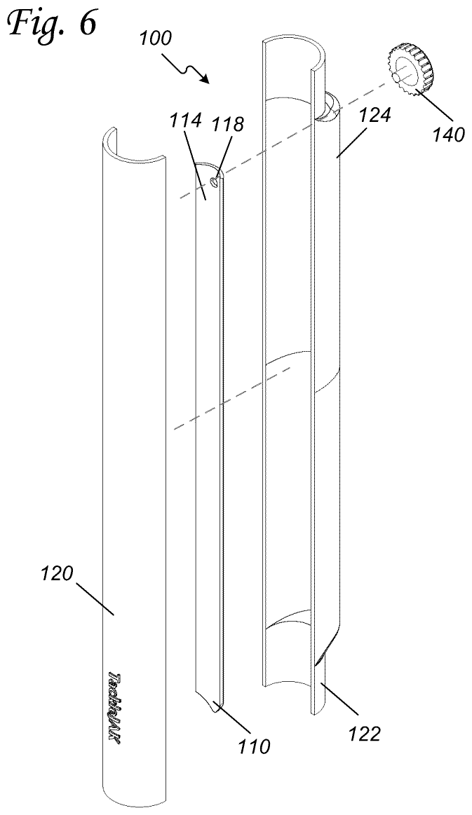

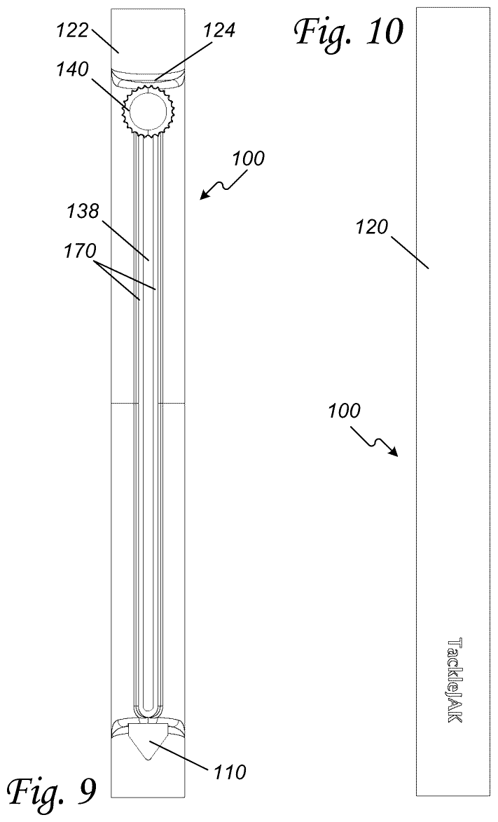

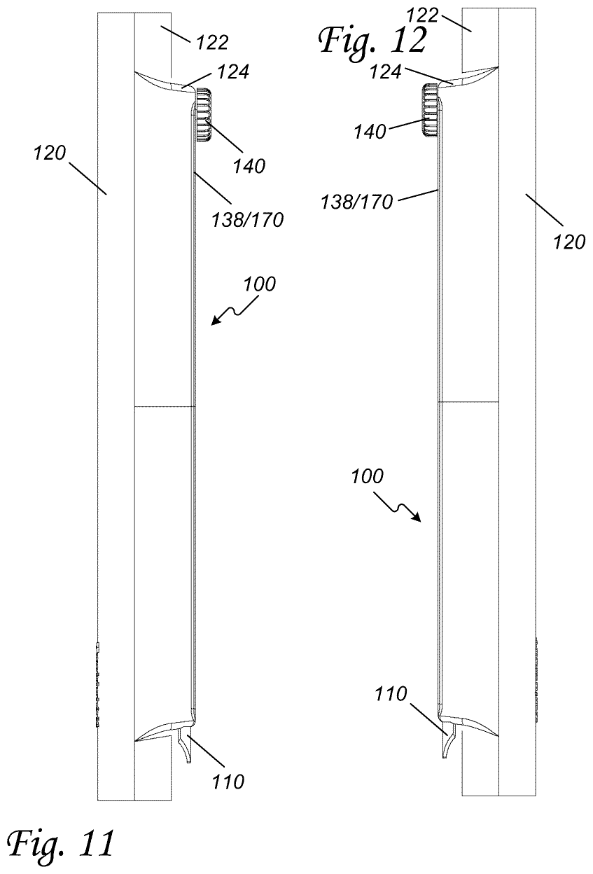

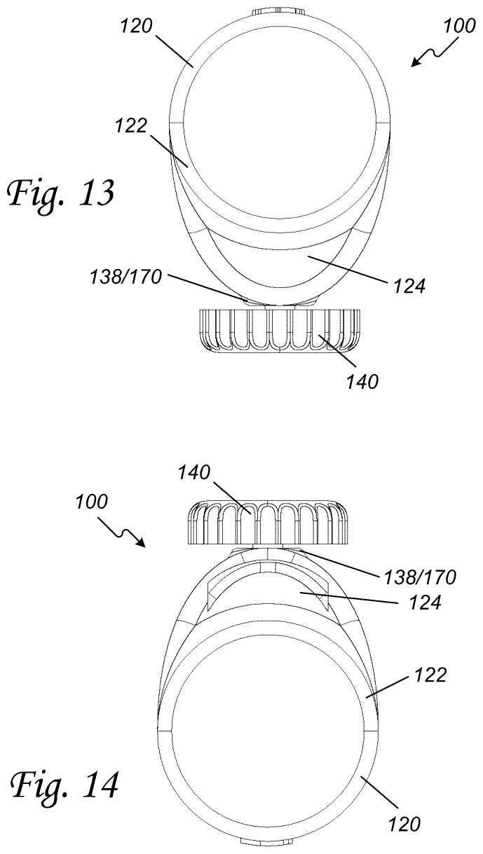

Turning now to the drawings in greater detail, it will be seen that in FIGS. 1-14, there is illustrated one example of a fishing rod holder system 100 with stake-length knob adjustment. FIGS. 1-5 illustrate perspective views of the fishing rod holder system 100 with stake-length knob adjustment. FIGS. 6-8 illustrate assembly views of the fishing rod holder system 100 with stake-length knob adjustment. FIG. 9 illustrates a front view of the fishing rod holder system 100 with stake-length knob adjustment. FIG. 10 illustrates a back view of the fishing rod holder system 100 with stake-length knob adjustment. FIG. 11 illustrates a left side view of the fishing rod holder system 100 with stake-length knob adjustment. FIG. 12 illustrates a right side view of the fishing rod holder system 100 with stake-length knob adjustment. FIG. 13 illustrates a top view of the fishing rod holder system 100 with stake-length knob adjustment. FIG. 14 illustrates a bottom view of the fishing rod holder system 100 with stake-length knob adjustment.

Referring to FIG. 1, the fishing rod holder system 100 with stake-length knob adjustment is shown in a perspective view, showcasing its primary components: the rod holder 120/122, the stake 114, and the knob 140. The rod holder 120/122 could be constructed from corrosion-resistant materials such as anodized aluminum, high-strength polymers, stainless steel to ensure durability in aquatic environments, a combination thereof, or other suitable materials. Stake 114, can be designed for insertion into various terrains and can be fabricated from steel, reinforced composites, or other suitable materials for optimal penetration strength. The knob 140 can incorporate a polymer grip with a threaded core, allowing secure tightening along the adjustment slot 138, extending and securing stake 114 at any user-desired length.

In an exemplary embodiment, the fishing rod holder system 100 with stake-length knob adjustment operates as a versatile and user-friendly solution for securely anchoring fishing rods. To deploy the system, the user begins by loosening the knob 140, which releases the clamping force holding the stake 114 within the stake retaining compartment 124. With the knob 140 loosened, the stake 114 can slide freely along the adjustment slot 138. The user adjusts the stake 114 to the desired length by sliding the knob 140 along the adjustment slot 138 until the optimal position is achieved for the terrain and fishing conditions.

A feature of the fishing rod holder system 100 with stake-length knob adjustment is that while the stake 114 can be repositioned to any desired length along the adjustment slot 138, it cannot be completely separated from the rod holder 120/122. The stake retaining compartment 124 is designed to limit the stake's movement to within the bounds of the adjustment slot 138, preventing accidental detachment during use or adjustment. This design addresses a common issue found in many prior approaches, where stakes can become separated from their holders, resulting in lost components and reduced functionality. By ensuring that the stake 114 remains securely tethered to the rod holder 120/122 at all times, the system enhances reliability, simplifies operation, and minimizes the risk of misplaced parts during fishing trips or transport.

Once the stake 114 is extended to the selected length, the user tightens the knob 140 against the raised ridge 170, which is designed to distribute the clamping force evenly across the stake half 122. This action locks the stake 114 securely in place, preventing unwanted movement during use. The raised ridge 170 also reinforces the structure of the adjustment slot 138, ensuring stability even under dynamic loads, such as when a fish strikes the fishing rod 202.

The user then inserts the pointed end 110 of the stake 114 into the earth. The tapered design of the pointed end 110 minimizes insertion force, enabling the system to be anchored in various terrains, including loose sand, compact soil, rocky ground, or other suitable terrain. Unlike prior approaches that rely on fixed or non-retractable stakes, this design provides flexibility in stake length, allowing for customized adjustments based on environmental needs. The system holds the fishing rod 202 securely in position, maintaining balance and resisting tipping even under lateral forces or high tension in the fishing line.

After the fishing session is complete, the system is easily retracted and stored. The user first removes the fishing rod holder system 100 with stake-length knob adjustment from the earth by pulling upward on the rod holder 120/122. Knob 140 is then loosened to release stake 114, allowing it to slide back into the stake retaining compartment 124 along the adjustment slot 138. Once stake 114 is fully retracted, the knob 140 is tightened against the raised ridge 170, locking stake 114 securely within the rod holder 120/122, stake retaining compartment 124. This compact configuration minimizes the risk of accidental injury from the pointed end 110 during transport and provides a streamlined form for storage.

This design differentiates itself from prior approaches through its adjustable stake length, which eliminates the need for separate components or tools to adapt to different terrains. Many prior approaches rely on fixed stakes, limiting their usability in varying ground conditions and forcing users to carry additional accessories to achieve similar functionality. Furthermore, the integration of the adjustment slot 138 with the raised ridge 170 provides enhanced structural stability and prevents deformation under high stress, addressing common durability issues observed in earlier systems.

Additionally, the use of a threaded knob 140 as the primary locking mechanism introduces a level of precision and ease of use not found in earlier designs. Prior approaches often utilize friction-based or snap-fit mechanisms, which may loosen over time or fail to provide sufficient clamping force. The threaded engagement of the knob 140 with the stake attachment hole 118 ensures a secure hold, even under significant tension from a fishing rod 202 in use. This design also incorporates corrosion-resistant materials, such as stainless steel, anodized aluminum, composite, or other suitable materials to withstand prolonged exposure to moisture, salt, and other environmental factors, further enhancing its longevity compared to traditional solutions.

By combining these features—adjustable stake length, superior clamping mechanisms, and durable materials—the fishing rod holder system 100 with stake-length knob adjustment provides a highly adaptable and reliable solution for anglers. This design not only meets the practical demands of modern fishing but also improves user convenience and safety, making it a significant advancement over prior approaches.

In another exemplary embodiment, the fishing rod holding system 100 can be manufactured integrally with the handle of the fishing rod 202, eliminating the need for retrofitting. This integrated design could enhance the durability, usability, and aesthetic appeal of the fishing rod, providing anglers with a seamless solution for hands-free rod support during fishing sessions.

In this configuration, the rod holder 120/122 could be designed as a structural component of the handle of the fishing rod 202. The stake half 122 and support half 120 might be molded directly into the handle's body using high-strength materials, such as glass-reinforced polymers, carbon fiber composites, lightweight aluminum alloys, or other suitable materials. These materials provide a balance of strength, weight reduction, and resistance to environmental factors like moisture, UV exposure, and salt corrosion.

The stake retaining compartment 124 could be incorporated within the interior of the handle of the fishing rod 202, extending along a portion of its length. The adjustment slot 138, also integrated into the handle design, might run along the exterior surface, allowing the stake 114 to slide in and out for use or storage. The knob 140, similarly, could be embedded within the handle structure, providing an ergonomic adjustment mechanism that blends seamlessly with the rod's overall design.

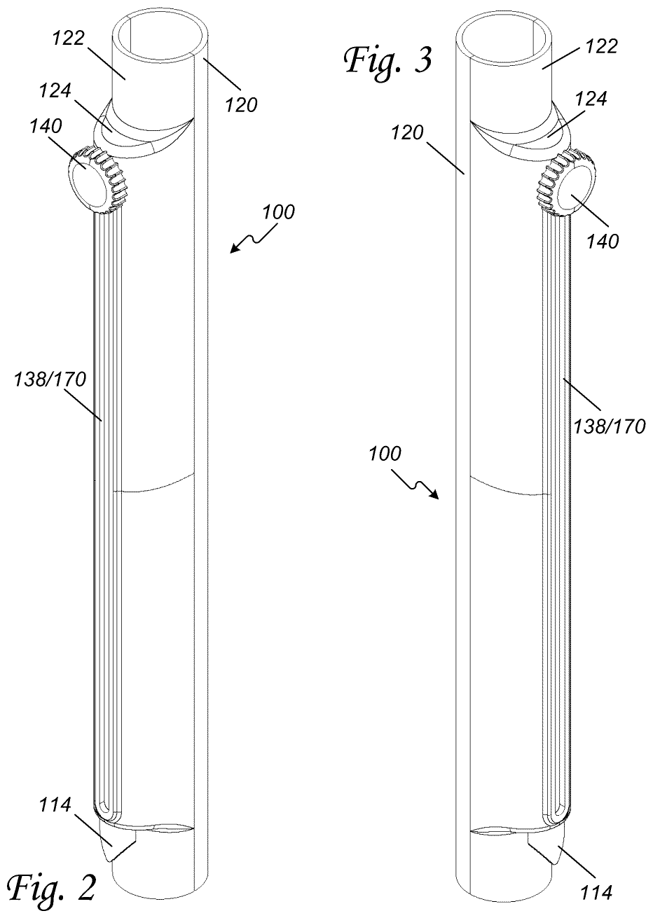

Referring to FIGS. 2 and 3, perspective views show the pointed end 110 of the stake 114 illustrates its sharp, tapered design for easy insertion into dense soils. The stake retaining compartment 124 is visible within the stake half 122, providing a secure channel for the stake 114 to slide smoothly. The adjustment slot 138 facilitates precise positioning of the stake 114 to a desired length, with the knob 140 securing it against unintended movement. This view demonstrates how the stake retaining compartment 124 and adjustment slot 138 operate together to allow efficient adjustment of the stake 114.

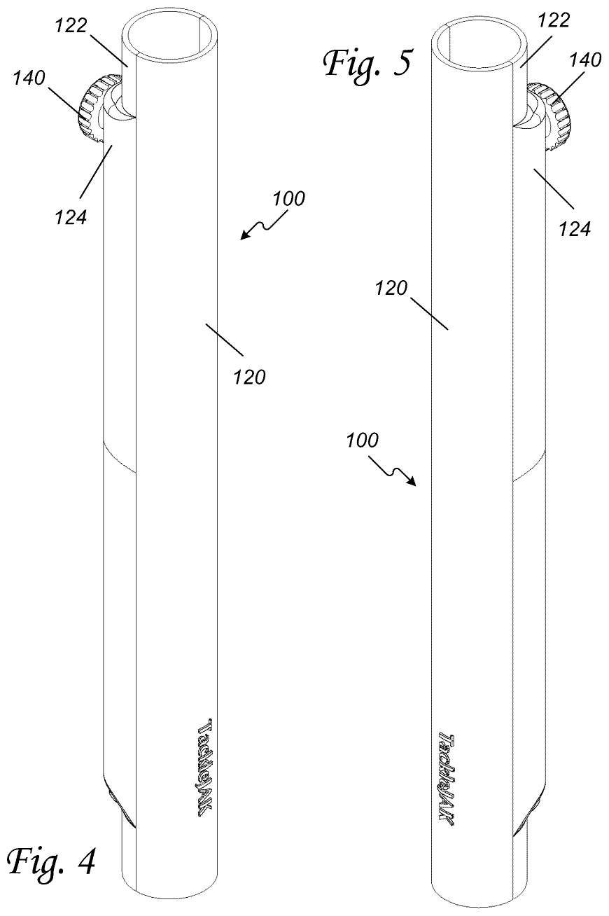

Referring to FIGS. 4 and 5, the perspective views emphasizes the support half 120 of the rod holder 120/122, which is designed to securely cradle the fishing rod 202 during use. The support half 120 is contoured to accommodate various fishing rod handle shapes and sizes, ensuring a snug fit that minimizes movement. The interior surface of the support half 120 might include cushioned inserts made from materials such as rubber, silicone, or thermoplastic elastomers. These inserts could provide additional grip to prevent slippage, even when the rod is subjected to vibrations, lateral forces, or wet conditions. The cushioning effect of these inserts also protects the finish and integrity of the fishing rod handle, preventing wear or damage during extended use.

To further enhance functionality, the support half 120 could incorporate textured surfaces or patterned grooves on the interior cushioning material. These features might work in conjunction with the rod's surface to provide a more stable grip, even when the rod holder 120/122 is exposed to environmental factors like rain or salt spray. Additionally, the cushioned inserts could be removable or replaceable, allowing users to maintain or customize the system for specific rod types or personal preferences.

The robust design of the support half 120 ensures that the fishing rod 202 remains firmly anchored in the rod holder 120/122, even under dynamic conditions, such as sudden strikes from fish or high tension in the fishing line. By combining structural integrity with protective features, the support half 120 not only enhances the reliability of the fishing rod holder system 100 but also ensures that the fishing rod remains in optimal condition throughout its lifespan.

Referring to FIG. 6, the assembly view illustrates the components disassembled, showing the stake 114, the stake half 122, and the knob 140 as individual elements. This view highlights the alignment of the stake attachment hole 118 with the adjustment slot 138, demonstrating how the knob 140 could be threaded manually to secure the stake 114 in place.

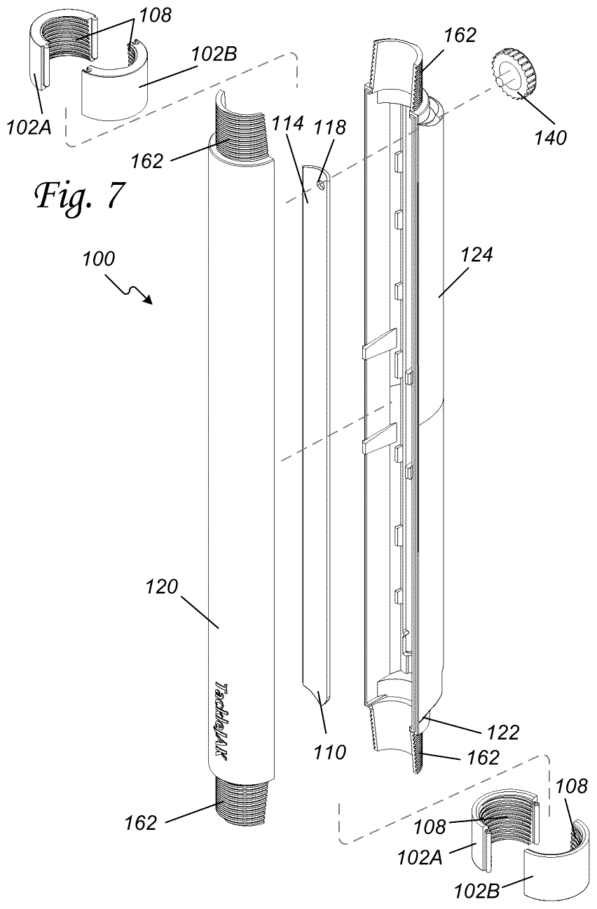

Referring to FIG. 7, this assembly view highlights the threaded tabs 162 located at the ends of the rod holder 120/122. The threaded tabs 162 are positioned such that a slight gap exists between them, allowing for compression when the interlocking connectors 102A/102B are attached. This intentional spacing enables the interlocking connectors 102A/102B to draw the threaded tabs 162 together as they are tightened, ensuring a secure grip on the fishing rod 202 without damaging its surface. This design feature provides a dynamic tightening mechanism that accommodates fishing rods of various diameters.

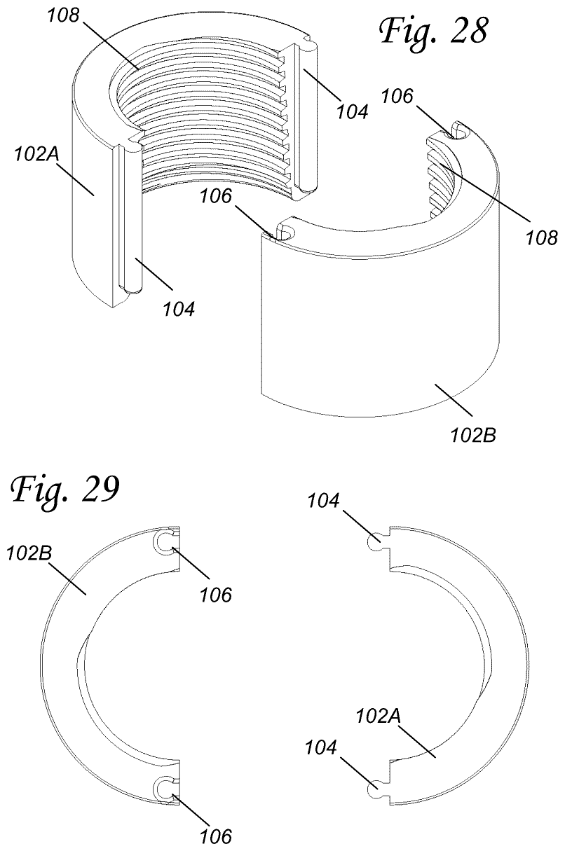

The interlocking connectors 102A/102B, as better illustrated in at least FIGS. 28 and 29, allow the rod holder 120/122 as well as the interlocking connector halves 102A/102B to be easily wrapped around the fishing rod 202, even in scenarios where the rod is equipped with a reel or features an oversized handle end. The first interlocking connector half 102A and the second interlocking connector half 102B are configured to interlock together by way of locking stems 104 and locking grooves 106. When the two halves interlock, they form along the interior surface, interlocking connector threads 108 that can be screwed onto the threaded tabs 162 located at each end of the rod holder 120/122.

As the interlocking connector 102A/102B is tightened, it compresses the threaded tabs 162, drawing them together and tightening the rod holder 120/122 securely around the fishing rod 202. This action ensures that the rod is held firmly in place, minimizing slippage during use while distributing clamping forces evenly across the rod's surface to prevent damage.

To maintain interlocking connector 102A/102B alignment during assembly, the interlocking connector 102A/102B incorporates locking groove end caps 112. The locking groove end caps 112 limits the travel distance of the locking stems 102 within the locking grooves 106, ensuring that the interlocking connector threads 108 remain aligned during use, preventing cross-threading or misalignment that could compromise the connector's effectiveness. The locking groove end cap 112 also stabilizes the connection between the locking stems 104 and locking grooves 106, preserving the structural integrity of the interlocking connector 102A/102B even under dynamic forces.

This innovative interlocking mechanism significantly improves ease of use and versatility compared to prior approaches. Unlike conventional systems that require cumbersome adjustments or are incompatible with rods featuring large reel housings or handle ends, this design accommodates a wide range of rod configurations without requiring the user to remove or disassemble the reel. By simplifying the process of attaching and securing the rod holder 120/122 to the fishing rod 202, this system enhances user convenience while maintaining a robust and reliable grip.

Moreover, the use of durable materials for interlocking connectors 102A/102B, such as reinforced polymers, anodized aluminum, or other suitable materials, ensures resistance to wear and environmental factors. This design balances ease of use with strength and adaptability, offering anglers a superior solution for securely attaching the rod holder 120/122 to their fishing equipment.

The exploded assembly view provides a detailed illustration of the interaction between the stake 114, the stake retaining compartment 124, the adjustment slot 138, and the interlocking connectors 102A/102B. This view highlights how the various components of the fishing rod holder system 100 work together to deliver a secure and adjustable solution for anchoring a fishing rod 202.

The stake 114 is positioned within the stake retaining compartment 124, where it is guided by the adjustment slot 138 along the length of the stake half 122. The knob 140, when loosened, releases the clamping force on the stake 114, allowing it to slide freely within the adjustment slot 138. This sliding mechanism enables users to extend or retract the stake 114 based on terrain conditions or user preferences, offering unparalleled flexibility compared to fixed-length stakes.

At both ends of the rod holder 120/122, the interlocking connectors 102A/102B play a dual role. First, these connectors securely hold the stake half 122 and the support half 120 together. The locking stems 104 of the first interlocking connector half 102A engage with the locking grooves 106 of the second interlocking connector half 102B, forming a robust connection. The locking groove end cap 112 ensures that the locking stems 104 and locking grooves 106 remain aligned, preventing accidental disassembly or misalignment during operation.

Second, the interlocking connectors 102A/102B serve to tighten the rod holder 120/122 around the fishing rod 202. Once the interlocking connectors 102A/102B are secured onto the threaded tabs 162 at each end of the rod holder 120/122, the connectors can be screwed together using the interlocking connector threads 108. This action compresses the threaded tabs 162, drawing the support half 120 and the stake half 122 tightly around the fishing rod 202. The result is a firm grip that prevents the rod holder 120/122 from shifting or rotating during use, even under the dynamic forces exerted by a fishing rod 202 under tension.

This design ensures that the rod holder 120/122 remains securely attached to the fishing rod 202 while maintaining adjustability for the stake 114. The interlocking connectors 102A/102B not only enhance the structural integrity of the system but also simplify the assembly and disassembly process, allowing users to quickly and efficiently set up or store their fishing equipment. By combining these functions into a single, cohesive system, the fishing rod holder system 100 delivers a reliable and user-friendly solution for anglers in various environments.

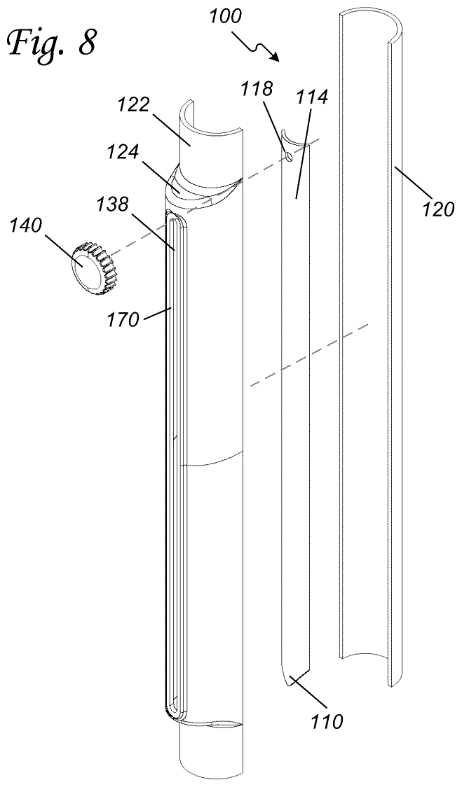

Referring to FIG. 8, another assembly view demonstrates the modular design of the rod holder 120/122. The stake 114, when fully retracted, fits compactly within the stake retaining compartment 124, allowing the system to be safely stored or transported. The knob 140 ensures stake 114 remains securely in place during storage.

Referring to FIG. 9, the front view highlights the symmetrical design of the rod holder 120/122. The alignment of the stake half 122 and the support half 120 creates a cradle for the fishing rod 202, accommodating a wide range of rod diameters. The central positioning of the knob 140 along the adjustment slot 138 enhances accessibility and ease of adjustment.

Referring to FIG. 10, the back view showcases the structural integrity of the stake retaining compartment 124. This view illustrates how the stake 114, when retracted, is securely housed within the rod holder 120/122, protecting the pointed end 110 from accidental damage or injury.

Referring to FIG. 11, the left side view highlights the operational alignment of the knob 140 with the adjustment slot 138 and the stake attachment hole 118. This figure illustrates how tightening the knob 140 against the raised ridge 170 prevents movement of the stake 114 under dynamic loads, such as those encountered during fishing.

Referring to FIG. 12, the right side view mirrors the left, providing additional clarity on the interaction of components. The symmetry of the rod holder 120/122 ensures that forces are evenly distributed, maintaining stability even under lateral pressure from the fishing rod 202.

Referring to FIG. 13, the top view illustrates the uniform alignment of the stake retaining compartment 124 and the adjustment slot 138. This view emphasizes the robustness of the connection between the stake 114 and the rod holder 120/122, ensuring consistent performance over extended use.

Referring to FIG. 14, the bottom view highlights the underside of the stake half 122, including the adjustment slot 138 and the raised ridge 170. This figure demonstrates how knob 140 interacts with the raised ridge 170 to lock the stake 114 securely for use or storage.

Fishing Rod Holder System with Stake-Length Pressure Ribs

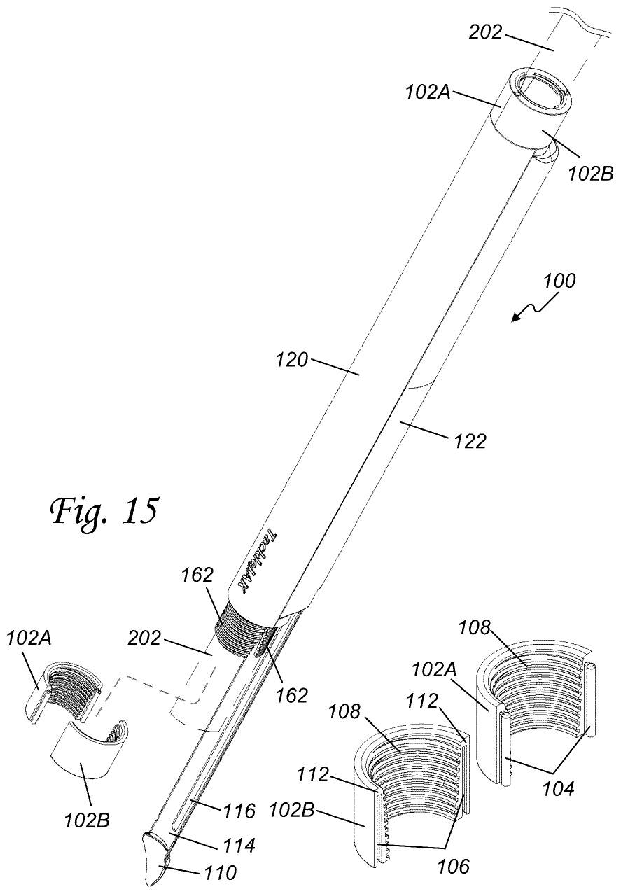

Referring to FIGS. 15-29, the fishing rod holder system 100 with stake-length pressure ribs 128 is illustrated, demonstrating a sophisticated configuration designed to secure the rod holder 120/122 to a fishing rod 202. This design employs a rib pad 126 with pressure ribs 128 and integrated rib push ridge 164, a pressure pad pusher 130 with a push ridge 166, and a locking tray 132 with locking notches 134 to ensure a secure, adjustable, and stable attachment. The interlocking connectors 102A/102B and threaded tabs 162 further enhance functionality by providing precise compression and ease of assembly.

In an exemplary embodiment, in operation, the fishing rod holder system 100 with stake-length pressure ribs 128 works as follows. The user begins by assembling the system onto the fishing rod 202. The rib pad 126, which comprises a plurality of pressure ribs 128 and a rib push ridge 164, can be positioned against the handle of the fishing rod. The pressure pad pusher 130, equipped with a push ridge 166, applies even force to the rib push ridge 164 engaging and compressing the pressure ribs 128 against the handle of the fishing rod 202. This configuration ensures the rib pad 126 conforms securely to the fishing rod 202, creating a stable, non-slip, and vibration-resistant grip.

The locking tray 132, which comprises locking notches 134, interacts with locking tabs 136 on the interior surface of the stake half 122 to secure the assembly. The locking notches 134 align with the locking tabs 136, preventing unwanted movement or misalignment during operation. This interlocking mechanism ensures that the pressure pad pusher 130, rib pad 126, and rod holder 120/122 are held firmly in place around the fishing rod 202.

In an exemplary embodiment, the pressure pad pusher 130 is designed to be more rigid than the rib pad 126. This rigidity ensures that, under compression, the rib pad 126 deforms and conforms to the contours of the handle of the fishing rod 202. Meanwhile, the pressure pad pusher 130 applies consistent and even pressure along the rib push ridge 164, ensuring a secure and stable attachment without damaging the rod handle.

In operation, to apply or adjust the gripping force, the interlocking connectors 102A/102B are secured onto the threaded tabs 162 located at the ends of the rod holder 120/122. The threaded tabs 162 are designed with a slight gap between them, which allows for controlled compression as the interlocking connectors 102A/102B are tightened. As the interlocking connectors 102A/102B engage, they draw the threaded tabs 162 together, compressing the rod holder 120/122 and applying a uniform gripping force to the pressure pad 130 and fishing rod 202.

The pressure ribs 128 along the rib pad 126 distribute the applied force evenly along the length of the handle of the fishing rod 202, preventing localized stress points and ensuring a secure non-slip fit. The push ridge 166 of the pressure pad pusher 130 amplifies this compression by pressing firmly into the rib push ridge 164, further enhancing stability. This design eliminates slippage and ensures that the fishing rod 202 remains securely anchored within the rod holder 120/122, even under dynamic forces such as casting or strikes from fish.

To disassemble or adjust the system, the user loosens the interlocking connectors 102A/102B, reducing the compression on the threaded tabs 162 and allowing for easy repositioning of the pressure ribs 128 or removal of the fishing rod 202. The modularity of this design enables quick and tool-free adjustments, making it highly adaptable to varying rod sizes and user preferences.

This innovative configuration, incorporating the rib pad 126, pressure pad pusher 130, rib push ridge 164, push ridge 166, locking tray 132, and interlocking connectors 102A/102B, sets this design apart from prior approaches. Earlier designs often relied on friction-based or single-point clamping mechanisms that lacked the precision and uniformity provided by this system. By utilizing a combination of pressure distribution and secure interlocking features, the fishing rod holder system 100 delivers enhanced stability, durability, and ease of use for modern anglers.

Referring to FIG. 15, this perspective view highlights the interlocking connector halves 102A/102B being secured to the rod holder 120/122. Better illustrated in at least FIGS. 28-29, the interlocking connectors 102A/102B, equipped with locking stems 104, locking grooves 106, and interlocking connector threads 108, engage with the threaded tabs 162 located at the ends of the rod holder 120/122. The threaded tabs 162 are designed with a slight gap between them, allowing for controlled compression as the interlocking connectors 102A/102B are tightened. This compression mechanism ensures the rod holder 120/122 securely grips the fishing rod 202 while maintaining the structural integrity of the system.

The compression mechanism in the fishing rod holder system 100 with stake-length pressure ribs 128 is an integrated assembly of components designed to apply controlled and uniform pressure to secure the fishing rod 202 within the rod holder 120/122. At its core, the mechanism relies on the interaction between the threaded tabs 162 and the interlocking connectors 102A/102B. The threaded tabs 162, positioned at the ends of the rod holder 120/122, are designed with a slight gap between them. This gap allows the tabs to flex inward when the interlocking connectors 102A/102B are tightened. The interlocking connectors, equipped with locking stems 104, locking grooves 106, and interlocking connector threads 108, engage with the threaded tabs 162 and draw them together during tightening. This inward compression secures the stake half 122 and support half 120 around the fishing rod handle, creating a stable and vibration-resistant grip.

Within the rod holder 120/122, the compression mechanism also includes the rib pad 126, which features a plurality of pressure ribs 128. These ribs distribute the compressive force evenly along the length of the fishing rod handle, preventing localized stress points that could lead to slippage or damage. The pressure pad pusher 130 plays a critical role by pressing onto the rib pad 126 by way of ripple ridges 168, amplifying the compressive force and ensuring consistent pressure distribution across the fishing rod handle. This interaction between the pressure pad pusher 130, rib pad 126, and pressure ribs 128 ensures a firm and secure attachment while protecting the rod's surface.

To maintain alignment and structural integrity during compression, the locking tray 132 and locking tabs 136 work together seamlessly. The locking tray, equipped with locking notches 134, engages the locking tabs 136 disposed on the interior surface of the stake half 122, ensuring the rod holder components remain securely aligned as the compression mechanism is engaged. This robust interlocking configuration prevents unwanted movement or misalignment, even under dynamic fishing conditions.

In operation, the compression mechanism enables precise control over the positioning and securing of the stake 114 without detachment from the rod holder 120/122. When the interlocking connectors 102A/102B on each end of the rod holder 120/122 are loosened, the stake 114 can be freely repositioned within the system to adapt to user preferences or terrain conditions. This ensures flexibility and ease of adjustment while maintaining the integrity of the assembly. Once the desired position of the stake 114 is achieved, tightening the interlocking connectors 102A/102B compresses the threaded tabs 162, locking the stake 114 securely in place for use or storage. This advanced design provides a robust and user-friendly solution, combining features such as pressure distribution, controlled compression, and interlocking alignment to deliver superior stability, durability, and convenience, addressing the shortcomings of prior approaches.

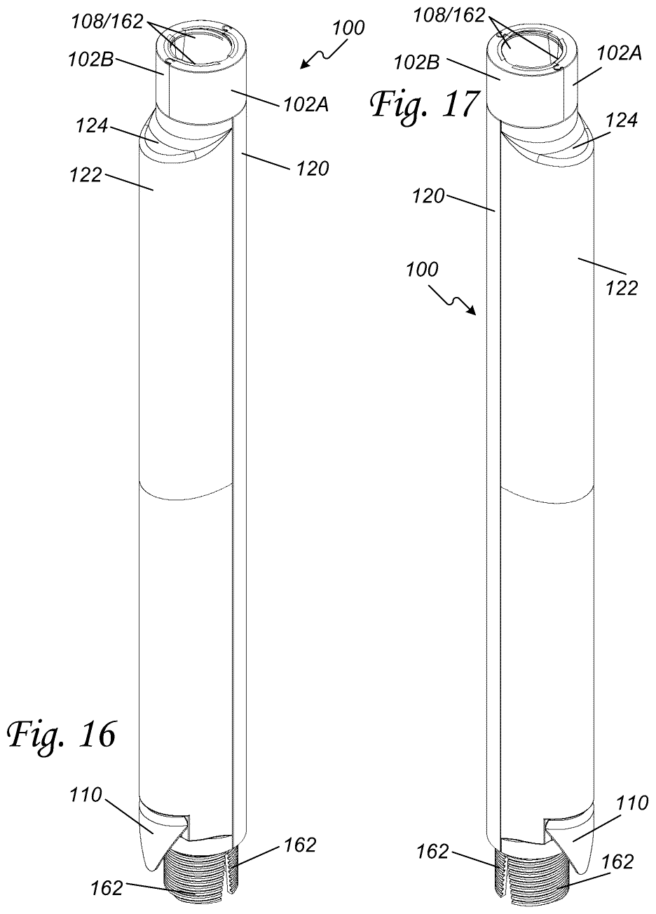

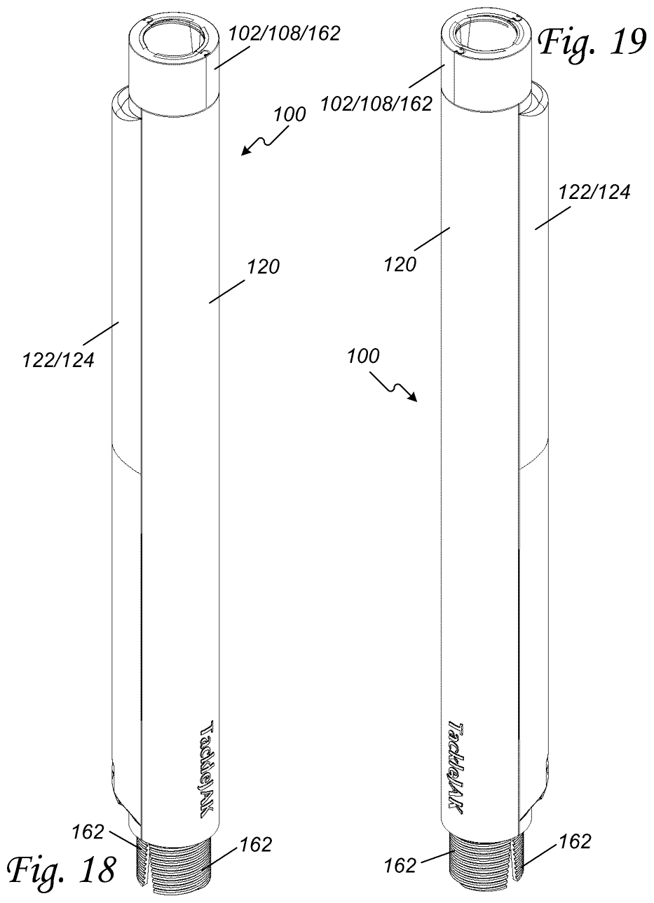

Referring to FIGS. 16-17, the perspective views focus on the stake half 122 side of the fishing rod holder system 100, and in FIGS. 18-19, the perspective views of the support half 120 side highlight its ergonomic design, which cradles the fishing rod 202 securely. The support half 120 and the stake half 122 are configured to work in conjunction with stake 114, rib pad 126, pressure pad pusher 130, locking tray 132, and other components, ensuring even distribution of clamping forces that allow precise stake position while abating fishing rod 202 slippage within the rod holder 120/122. In addition, this configuration allows the system to accommodate various rod sizes while providing reliable stability during use.

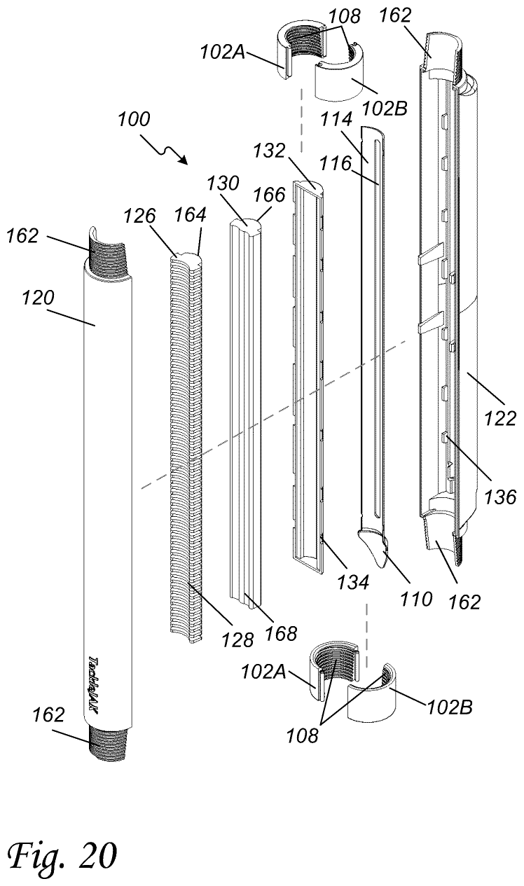

Referring to FIG. 20, the assembly view illustrates the interaction between the support half 120, rib pad 126, pressure pad pusher 130, locking tray 132, and stake 114. The stake 114 includes a stake slot 116 that engages with encumbrances in the stake half 122 and the stake retaining compartment 124, limiting travel and preventing separation of the stake 114 from the rod holder 120/122 during use. Additionally, the stake half 122 and interlocking connectors 102A/102B work together to secure the overall design.

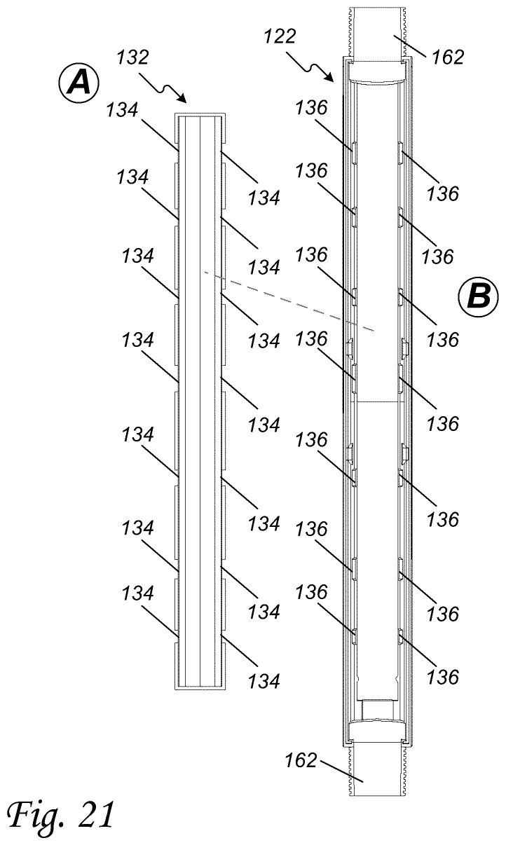

Referring to FIG. 21, this figure provides detailed views of the back side of locking tray 132 (reference ‘A’) and the interior surface of stake half 122 (reference ‘B’). The locking tray 132, equipped with locking notches 134, engages the locking tabs 136 on the stake half 122 to create a robust connection. This interlocking mechanism prevents unwanted movement or misalignment during operation, ensuring that all components remain securely in place under dynamic forces.

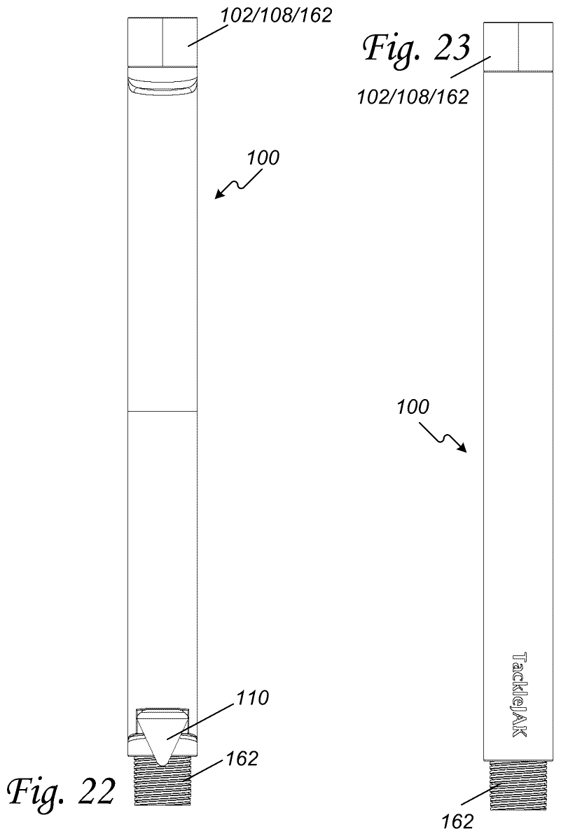

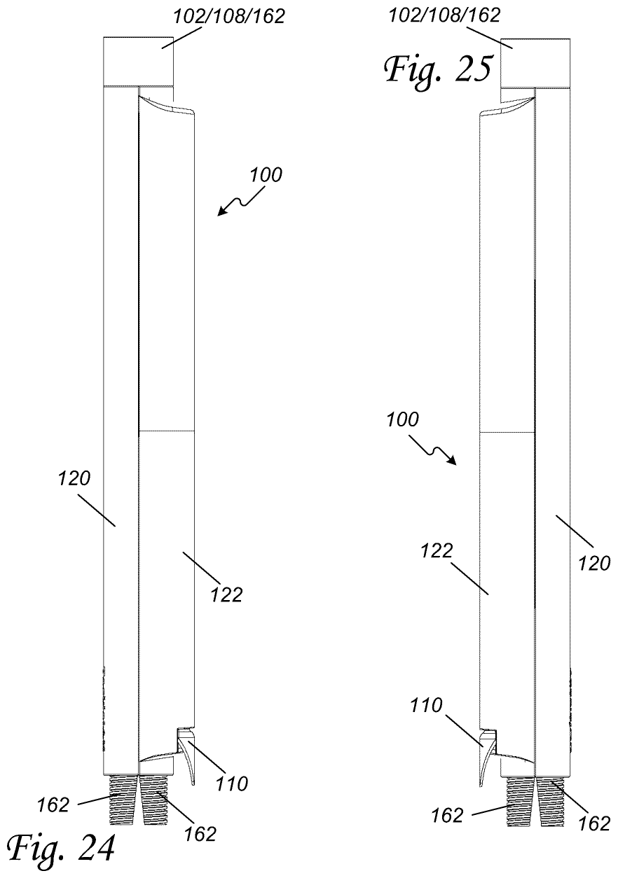

Referring to FIGS. 22-23, the front and back views highlight the functional precision and structural symmetry of the design, while in FIGS. 24-25, the left and right side views, showcase the sleek and cohesive aesthetic of the fishing rod holder system 100. The interplay of functional elements, such as the interlocking connectors 102A/102B, threaded tabs 162, is complemented by the clean lines and balanced proportions of the overall structure. This thoughtful integration of functionality and visual appeal ensures that the system not only performs reliably but also presents a polished, professional appearance, making it an attractive addition to any angler's gear.

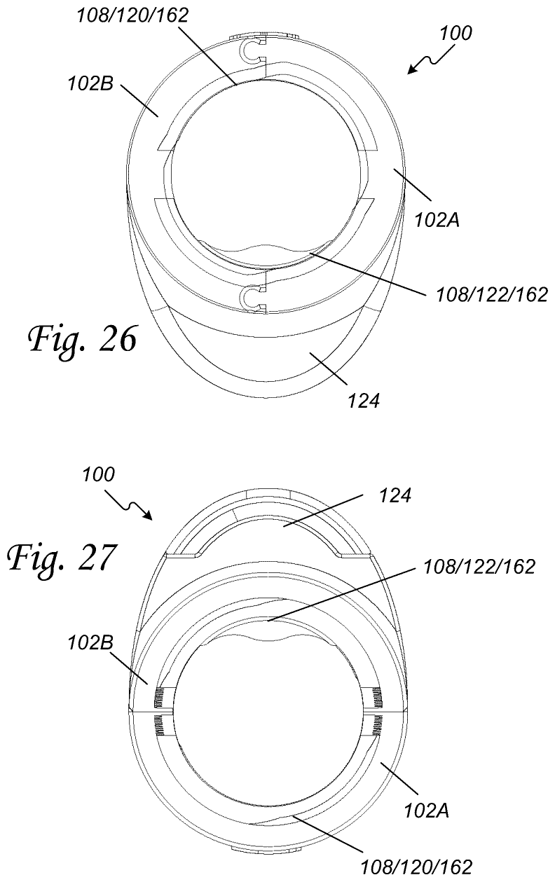

Referring to FIGS. 26-27, the top and bottom views illustrate the alignment of the interlocking connectors 102A/102B, the interlocking connector threads 108, and the threaded tabs 162. These views emphasize the precise positioning of these components, ensuring secure engagement and consistent performance during operation.

Referring to FIGS. 28 and 29, the perspective and top views of the interlocking connectors 102A/102B highlight key features, including the locking stems 104, locking grooves 106, and interlocking connector threads 108. These components work together to provide precise control over the compression applied to the threaded tabs 162, ensuring a secure and stable fit for the fishing rod holder system 100. These views emphasize the thoughtful design and functionality of the interlocking connectors, which play a critical role in the system's reliability and ease of use.

The fishing rod holder system 100 used with pressure ribs 128 stands out from prior approaches through its innovative combination of pressure distribution, interlocking components, and controlled compression mechanisms. Unlike traditional designs that rely on friction-based or single-point clamping systems, this design ensures even force distribution across the rod handle, preventing slippage and damage. The use of the rib pad 126, pressure pad pusher 130, and locking tray 132 provides a robust and adaptable solution for securing fishing rods in a variety of environments. This thoughtful integration of advanced features makes the fishing rod holder system 100 a superior tool for modern anglers.

This design distinguishes itself from prior approaches through its innovative integration of pressure distribution mechanisms, interlocking components, and controlled compression, addressing key shortcomings found in earlier systems. Traditional designs often rely on friction-based clamps or single-point locking mechanisms that can create uneven force distribution, leading to instability, slippage, or damage to the fishing rod handle. In contrast, the fishing rod holder system 100 with stake-length pressure ribs 128 introduces a multi-component configuration that ensures consistent performance, durability, and user convenience.

One of the standout features of this design is the rib pad 126, which incorporates a plurality of pressure ribs 128. These pressure ribs 128 are strategically positioned to distribute clamping forces evenly along the handle of the fishing rod 202, preventing localized stress points that could lead to deformation or wear. Unlike prior systems that apply clamping pressure directly to the rod handle, risking damage, this design uses the pressure ribs 128 and the rib pad 126 to create a cushioning layer that maintains a firm grip while protecting the fishing rod's 202 surface.

The pressure pad pusher 130 and its integrated push ridge 166 further enhance this force distribution by amplifying and evenly applying compression to the pressure ribs 128. This ensures that the system maintains a secure and vibration-resistant grip, even under dynamic forces such as casting or sudden strikes from fish. Earlier designs often fail to provide this level of stability, particularly in conditions where rods experience significant tension or lateral forces.

The locking tray 132 with locking notches 134 and the locking tabs 136 on the stake half 122 introduce an interlocking mechanism that ensures the components remain securely aligned during use. Prior systems frequently rely on friction or loose-fitting connections, which can shift or misalign under stress, compromising the stability of the setup. In contrast, the locking tray and locking tabs provide a robust and precise engagement, preventing movement and enhancing the overall structural integrity of the system.

The interlocking connectors 102A/102B and threaded tabs 162 offer controlled compression, allowing users to adjust the gripping force applied to the rod holder 120/122. The gap between the threaded tabs 162 is specifically designed to facilitate this compression, which is managed by tightening the interlocking connectors. This approach ensures a customized fit for various rod sizes while maintaining consistent pressure along the rod holder. Unlike older systems that often require external tools or complex adjustments, this design allows for tool-free operation, making it more user-friendly and efficient in the field.

Furthermore, the modular nature of this design enhances its adaptability and versatility. The combination of the rib pad 126, pressure pad pusher 130, locking tray 132, and interlocking connectors 102A/102B provides a customizable solution that can accommodate a wide range of fishing rod sizes and handle types. Earlier designs typically lack this flexibility, limiting their usability across different setups or requiring multiple attachments for similar functionality.

By addressing common pain points in prior approaches, such as uneven force distribution, risk of damage to the rod handle, and lack of stability under dynamic forces, the fishing rod holder system 100 with stake-length pressure ribs 128 delivers a superior solution for modern anglers. Its thoughtful engineering, durable materials, and intuitive operation set it apart as a highly reliable and versatile tool in the fishing gear market.

### Fishing Rod Holder System With Grip Clamps Adjustment

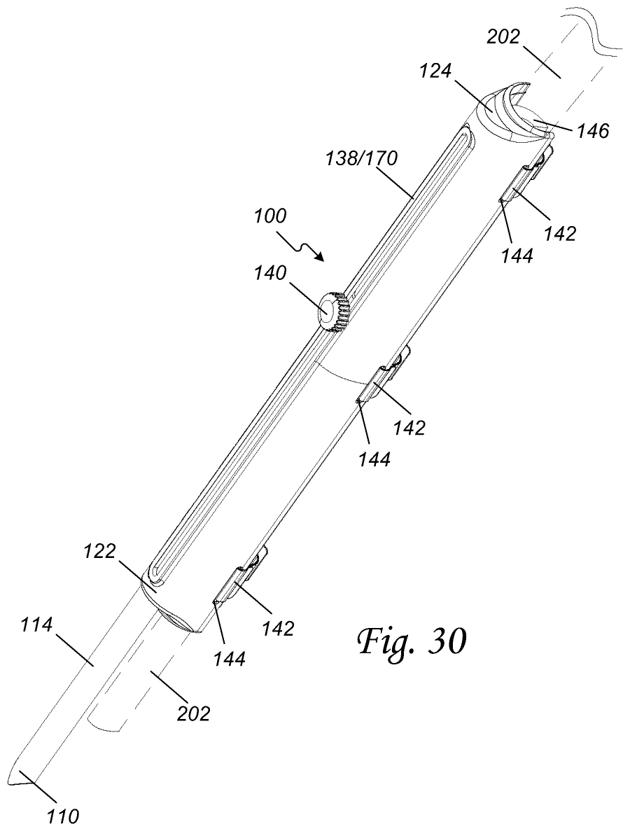

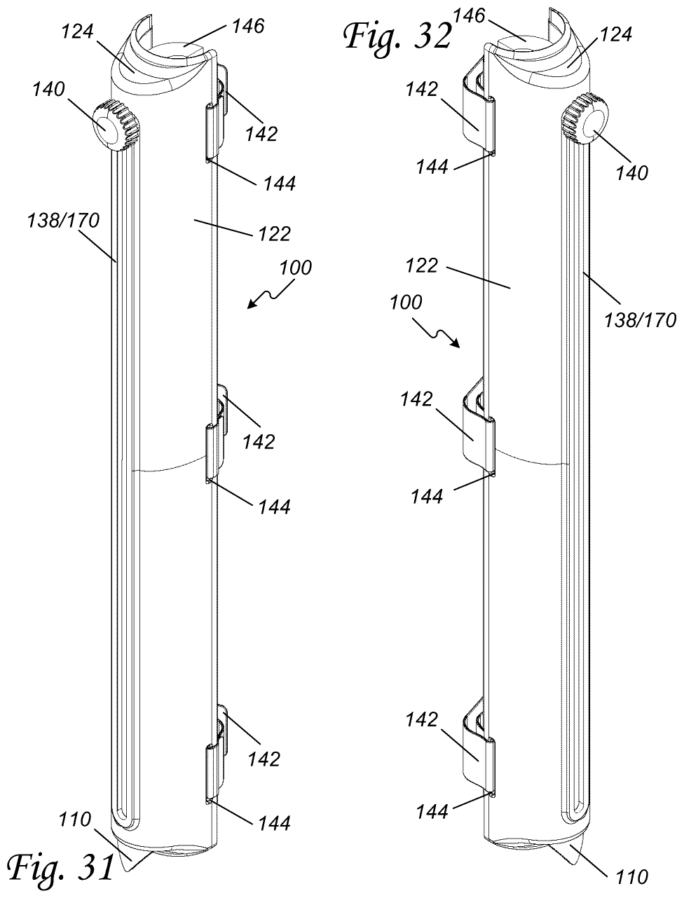

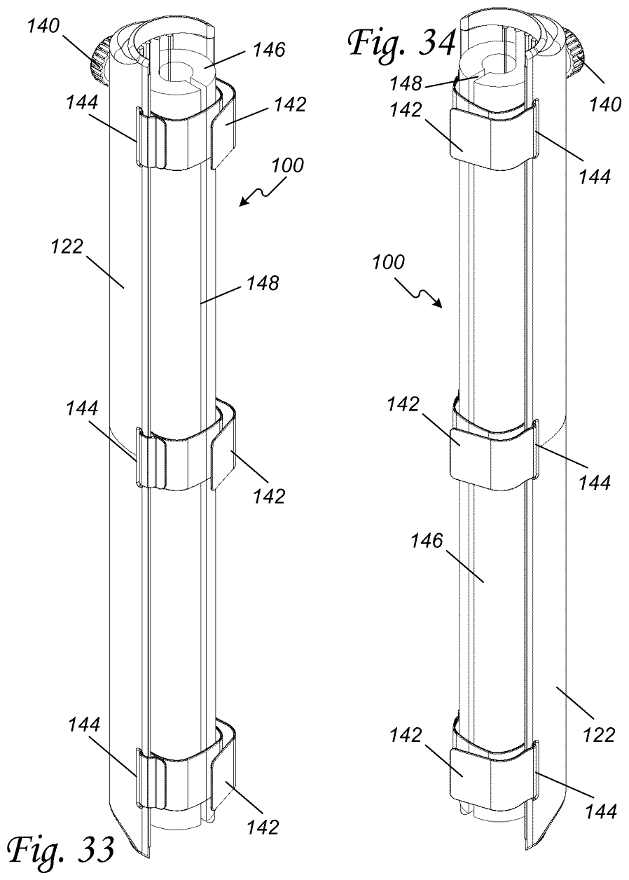

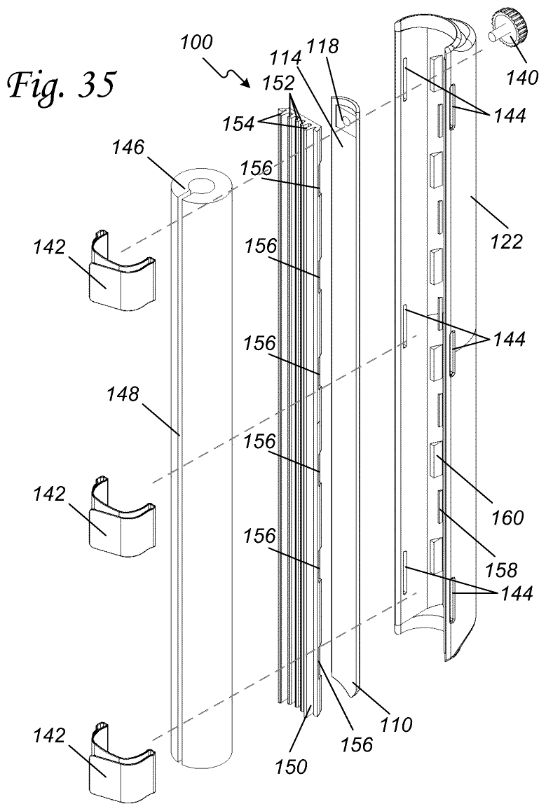

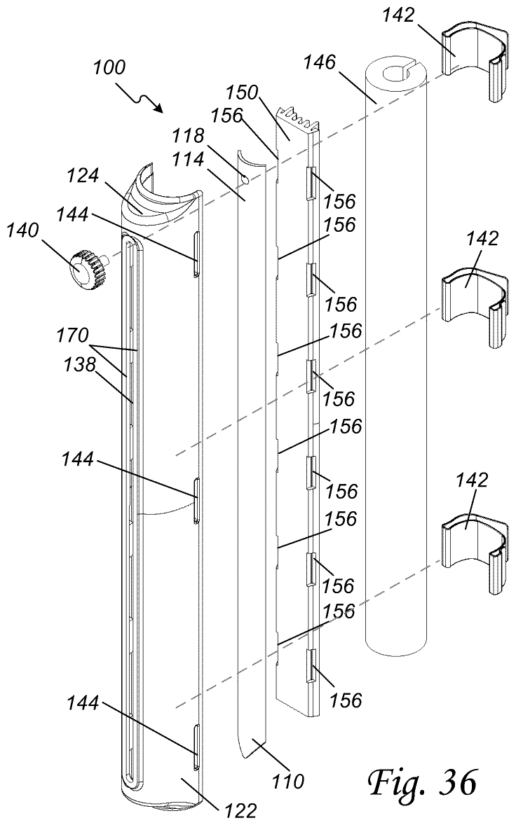

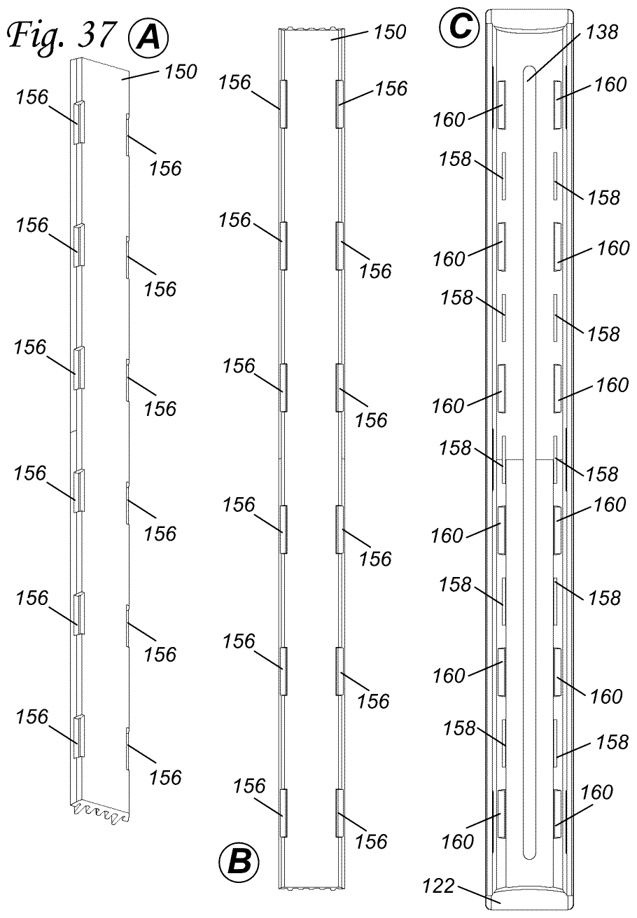

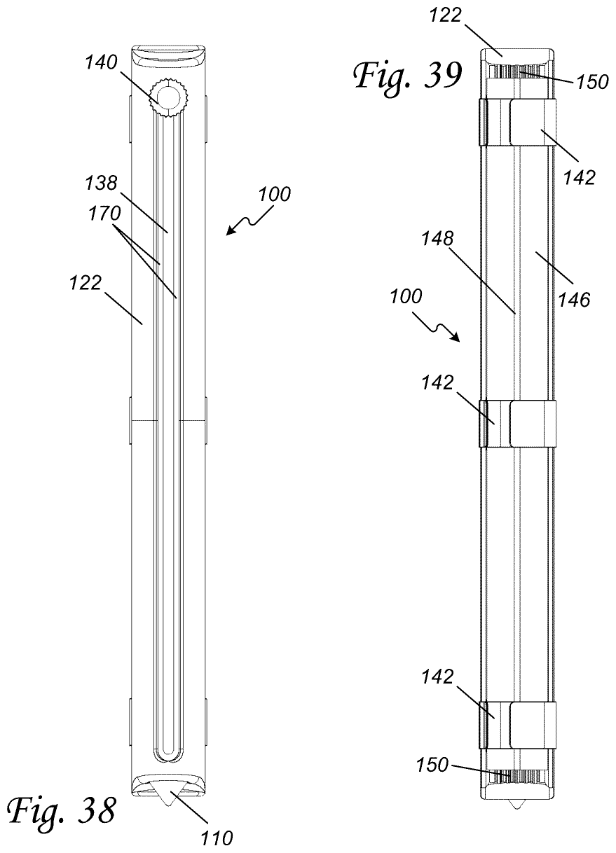

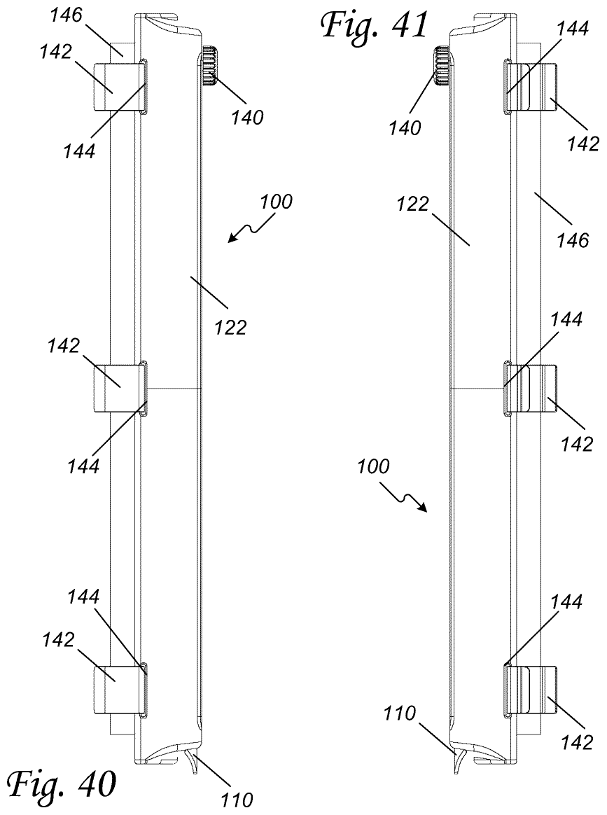

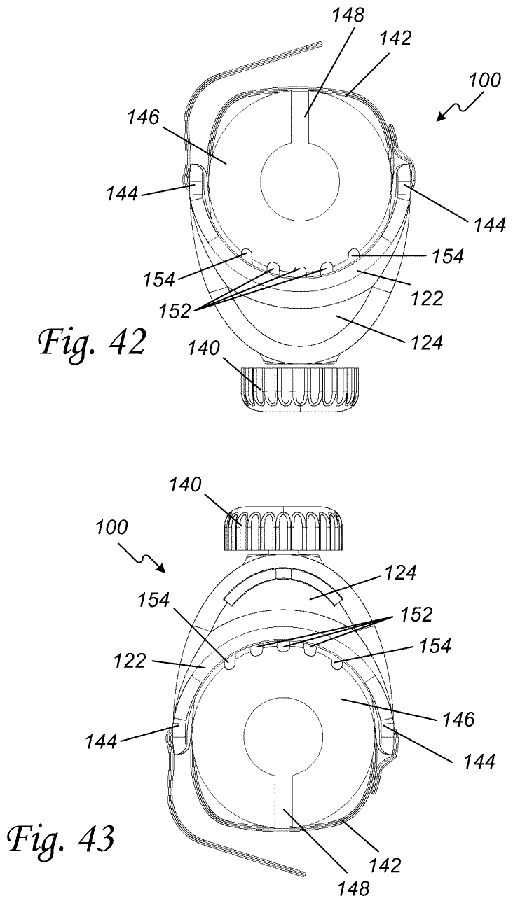

Referring to FIGS. 30-43, there is illustrated one example of a fishing rod holder system 100 with grip clamps 142. FIGS. 30-34 illustrate perspective views of the fishing rod holder system 100 with grip clamps 142. FIGS. 35-36 illustrate assembly views of the fishing rod holder system 100 with grip clamps 142. FIG. 37 illustrates views of the grip pad 150 and stake half 122. Reference ‘A’ is a back side perspective view of the grip pad 150, reference ‘B’ is a back side view of the grip pad 150, and reference ‘C’ is an interior view of the stake half 122. FIG. 38 illustrates a front view of the fishing rod holder system 100 with grip clamps 142. FIG. 39 illustrates a back view of the fishing rod holder system 100 with grip clamps 142. FIG. 40 illustrates a left side view of the fishing rod holder system 100 with grip clamps 142. FIG. 41 illustrates a right side view of the fishing rod holder system 100 with grip clamps 142. FIG. 42 illustrates a top view of the fishing rod holder system 100 with grip clamps 142. FIG. 43 illustrates a bottom view of the fishing rod holder system 100 with grip clamps 142

Referring to FIGS. 30-43, the fishing rod holder system 100 with grip clamps 142 is illustrated, showcasing a robust design that leverages grip clamps 142 to securely attach the rod holder 120/122 to a fishing rod 202. This design ensures a reliable and adjustable system that accommodates fishing rods of various sizes while providing superior stability and ease of use.

To retrofit the fishing rod holder system 100 with grip clamps 142 onto a fishing rod 202, the user begins by wrapping the grip collar 146 around the handle of the fishing rod 202. The grip collar 146, being flexible and self-contouring, conforms to the shape of the fishing rod handle, creating a secure foundation for the attachment. Next, the user places the stake half 122 of the rod holder 120/122 on top of the grip collar 146, aligning it for proper assembly.

The grip clamps 142 are then passed through the grip clamp slots 144 located along the perimeter of the stake half 122 and grip collar 146. Once each of the grip clamps 142 is threaded through the slots, the user removes any slack by pulling on the free ends of the grip clamps 142. This action compresses the grip pad 150 into the grip collar 146 and the interior of the stake half 122, ensuring a firm and secure connection. The grip pad 150, positioned between the grip collar 146 and the stake half 122, provides additional friction and stability, preventing slippage or rotation during use.

To complete the retrofitting process, the user folds each of the grip clamps 142 back onto itself, locking them in place to secure the rod holder 120/122 to the fishing rod 202. This method of attachment ensures that the system remains firmly fixed to the fishing rod handle, even under dynamic forces or environmental stresses, while still allowing for easy disassembly and adjustment if needed. The retrofitting process is intuitive and tool-free, making it convenient for anglers to set up the fishing rod holder system 100 in the field or adapt it for use with different fishing rods 202.

In operation, the fishing rod holder system 100 with grip clamps 142 operates as follows. The user begins by loosening the knob 140, which reduces the clamping force on the stake 114 and allows it to slide freely within the adjustment slot 138. By sliding the loosened knob 140 along the adjustment slot 138, the user adjusts the stake 114 to the desired length, optimizing the system's functionality for specific terrain conditions. Once the stake 114 is extended to the selected length, the user tightens the knob 140 against the raised ridge 170 located proximate to the adjustment slot 138. This action secures the stake 114 in place, ensuring that it remains stable during use and can withstand dynamic forces exerted by the fishing rod 202.

The user then inserts the pointed end 110 of the stake 114 into the earth, anchoring the fishing rod holder system 100 securely. The tapered design of the pointed end 110 facilitates effortless insertion into a variety of terrains, including loose sand, compacted soil, or rocky ground, without the need for additional tools. Unlike prior approaches that rely on fixed-length stakes or require disassembly for adjustments, this design offers seamless adjustability, allowing anglers to adapt to their environment with ease. The system holds the fishing rod 202 firmly in position, resisting lateral forces and vibrations that could otherwise destabilize the setup.

After fishing is complete, the user removes the fishing rod holder system 100 from the earth by pulling upward on the rod holder 120/122. The knob 140 is loosened again, releasing the stake 114 and enabling it to slide back into the stake retaining compartment 124 along the adjustment slot 138. Once the stake 114 is fully retracted, the user tightens the knob 140 against the raised ridge 170, securely locking the stake 114 within the rod holder 120/122 for safe storage and transport. This compact configuration minimizes the risk of injury from the pointed end 110 and ensures the system remains ready for future use.

This design distinguishes itself from prior approaches in several significant ways. Many earlier systems rely on non-adjustable or removable stakes, which can be difficult to adapt to varying ground conditions or are prone to being misplaced during transport or use. In contrast, the stake 114 in this design remains permanently connected to the rod holder 120/122, ensuring that all components are securely retained and easily accessible. The use of the adjustment slot 138 and the raised ridge 170 provides enhanced structural integrity, preventing deformation or slippage even under high stress, such as when a heavy fish pulls on the fishing rod 202.

Furthermore, the gripping mechanism of the rod holder 120/122, including the grip clamps 142, grip collar 146, and grip pad 150, offers a level of adaptability and precision that surpasses prior approaches. Earlier systems often employ friction-based or snap-fit mechanisms, which may loosen over time or fail to accommodate rods with varying handle sizes or shapes. This design utilizes a combination of flexible materials and secure clamping methods to provide a customized fit for a wide range of fishing rods 202, while also ensuring consistent performance in wet or corrosive environments.

In addition, A feature of the fishing rod holder system 100 with grip clamps 142 is that while the stake 114 can be repositioned to any desired length along the adjustment slot 138, it cannot be completely separated from the rod holder 120/122. The stake retaining compartment 124 is designed to limit the stake's movement to within the bounds of the adjustment slot 138, preventing accidental detachment during use or adjustment.

By integrating these features, the fishing rod holder system 100 with grip clamps 142 offers a robust, versatile, and user-friendly solution for modern anglers. Its ability to securely anchor a fishing rod while providing easy adjustments and enhanced durability makes it a substantial improvement over prior approaches, addressing common pain points and delivering a superior fishing experience.

Referring to FIGS. 30-34, the perspective views highlight the primary components of the fishing rod holder system 100 with grip clamps 142, including the rod holder 120/122, the grip clamps 142, the grip collar 146, the grip pad 150, and the stake 114. The rod holder 120/122, can be constructed from durable materials such as anodized aluminum, high-strength polymers, stainless steel, or other suitable materials that provide structural integrity and corrosion resistance for prolonged use in aquatic environments. The grip clamps 142, can be fabricated from flexible and strong materials such as metals, reinforced nylon, thermoplastic elastomers, or other suitable materials that can pass through aligned grip clamp slots 144 on the rod holder 120/122. These clamps compress the grip collar 146 and grip pad 150 against the fishing rod 202, ensuring a secure and vibration-resistant attachment. The grip collar 146, designed to flex and wrap around the fishing rod 202, provides a custom fit for rods of varying diameters, while the grip pad 150 enhances stability and prevents slippage, even under dynamic forces.

Referring to FIGS. 35-36, the assembly views provide a detailed look at how the grip clamps 142, grip collar 146, and grip pad 150 work together. The grip clamps 142 are threaded through the grip clamp slots 144 on the rod holder 120/122, positioning them for secure tightening around the fishing rod 202. As the clamps are tightened, they draw the grip collar 146 and the grip pad 150 snugly against the rod. The grip collar 146, being flexible, conforms to the shape of the rod handle, while the grip pad 150 acts as a stabilizing layer. Positioned between the stake half 122 and the grip collar 146, the grip pad 150 features friction-enhancing textures to maximize grip and prevent unwanted movement during use.

In an exemplary embodiment, the grip collar 146 includes a grip collar slot 148 that extends along its length. This slot creates a gap, allowing the grip collar 146 to be easily fitted around the handle of the fishing rod 202. The gap also enables compression of the grip collar 146, ensuring a tight, snug, and non-slip grip on the fishing rod handle.

Referring to FIG. 37, this figure provides a view of the grip pad 150 and its relationship with the stake half 122. Reference ‘A’ shows a back-side perspective of the grip pad 150, and reference ‘B’ shows a back-side view of the grip pad 150, highlighting grip pad notches 156. These notches engage with grip pad notch tabs 158 located on the interior of the stake half 122, ensuring the grip pad 150 remains securely in place. Reference ‘C’ illustrates the interior of the stake half 122, showing grip pad positioning tabs 160, which abut the edges of and align the grip pad 150 and prevent it from rotating or shifting movement under pressure during use.

In an exemplary embodiment, the grip pad perimeter ribs 154 and grip pad inner ribs 152 extend along the length of the front side of the grip pad 150. These ribs distribute contact with the grip collar 146, enhancing friction and stability. The taller grip pad perimeter ribs 154 create a concave cup effect on the front side of the grip pad 150, aligning more effectively with the circular contour of the grip collar 146. This design helps prevent shifting or rotation of the fishing rod holder system 100 during use.

Additionally, a plurality of grip pad positioning tabs 160 are disposed along the interior surface of the stake half 122. These grip pad positioning tabs 160 assist in aligning and maintaining the alignment of the grip pad 150 when the fishing rod holder system is assembled.

Referring to FIG. 38, the front view of the fishing rod holder system 100 with grip clamps 142 emphasizes the critical interaction between the knob 140, the adjustment slot 138, and the raised ridge 170. The knob 140 is centrally positioned along the adjustment slot 138, allowing users to precisely control the extension and retraction of the stake 114. This adjustability ensures that the fishing rod holder system 100 can be adapted to various terrains and user preferences with minimal effort.

The adjustment slot 138, running longitudinally along the stake half 122, provides a guided path for the knob 140 as it engages with the stake attachment hole 118. This configuration allows the stake 114 to move smoothly while preventing misalignment or unintended detachment during use. The raised ridge 170, positioned around the adjustment slot 138, reinforces the structural integrity of the system. When the knob 140 is tightened against the raised ridge 170, it locks the stake 114 securely in place, distributing clamping forces evenly to prevent movement or slippage under dynamic loads, such as those encountered when a fishing rod 202 is under tension.

This front view highlights the synergy between these components, demonstrating how the knob 140, adjustment slot 138, and raised ridge 170 work together to deliver a reliable, user-friendly, and robust solution for anchoring the fishing rod 202 in diverse environments. The design's attention to these details ensures stability, ease of adjustment, and long-term durability, making it an essential tool for anglers.

Referring to FIG. 39, the back view emphasizes the connection between the grip pad 150 and the stake half 122. The grip pad 150 is visible from this angle, demonstrating its role in distributing clamping forces evenly across the surface of the fishing rod 202. This ensures the rod remains undamaged while maintaining a firm, secure grip. The grip pad notches 156 engage with grip pad notch tabs 158 on the interior surface of the stake half 122. This interaction locks the grip pad 150 in place, preventing slippage or movement during use, even when the fishing rod 202 is subjected to high tension or lateral forces.

Referring to FIG. 40, the left-side view highlights the profile of the fishing rod holder system 100 with grip clamps 142. The grip clamps 142 are shown passing through the aligned grip clamp slots 144 on the rod holder 120/122. This view further emphasizes the secure fit of the grip collar 146 and grip pad 150 around the fishing rod 202, providing a stable and balanced attachment that minimizes vibrations during use.

Referring to FIG. 41, the right-side view mirrors the left, offering additional clarity on the interaction between the grip clamps 142, grip clamp slots 144, and other components. The symmetrical configuration of the grip clamps 142 ensures uniform pressure distribution around the fishing rod 202, contributing to both stability and ease of use.

Referring to FIG. 42, the top view highlights the alignment of the grip collar 146 with the rod holder 120/122. The grip collar 146 conforms to the fishing rod 202, while the grip clamps 142 apply consistent pressure to tighten the assembly securely. This view also demonstrates how the rod holder 120/122 cradles the fishing rod 202, preventing unwanted movement.

Referring to FIG. 43, the bottom view provides an underside perspective of the rod holder 120/122. The alignment of the grip clamp slots 144 and the placement of the stake retaining compartment 124 are clearly visible. The knob 140 interacts with the adjustment slot 138 to allow precise positioning of the stake 114, ensuring the fishing rod holder system 100 can adapt to a variety of terrains and user preferences.

The fishing rod holder system 100 with grip clamps 142 combines flexibility, strength, and precision to deliver a superior solution for anglers. The use of durable materials, innovative gripping mechanisms, and thoughtful design ensures the system provides a reliable and secure attachment for fishing rods, accommodating a range of conditions and rod sizes. This design not only enhances functionality but also improves user convenience, setting it apart from traditional approaches.

The capabilities of the present invention can be implemented in software, firmware, hardware, or some combination thereof.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A fishing rod holder system comprising:
a rod holder comprising a stake half and a support half, wherein the rod holder is configured to attach around a handle of a fishing rod, the stake half comprising a stake retaining compartment along an interior surface of the stake half, and an adjustment slot that runs along a portion of the length of the stake half parallel to the fishing rod;
a stake having a stake attachment hole, the stake configured to fit within the stake retaining compartment, allowing the stake to be retracted for storage into and extended for use from the rod holder in a slidable manner; and
a knob configured to pass through the adjustment slot and thread into the stake attachment hole, wherein loosening the knob allows the stake to slide in and out of the rod holder, and tightening the knob secures the stake in place for use or storage.

2. The fishing rod holder system of claim 1, wherein the rod holder further comprising a threaded tab at each end of the rod holder.

3. The fishing rod holder system of claim 2, further comprising:
an interlocking connector that is curvilinear in shape, the interlocking connector comprising:
a first interlocking connector half; and
a second interlocking connector half configured to interlock with the first interlocking connector half.

4. The fishing rod holder system of claim 3, wherein:
the first interlocking connector half further comprising a locking stem along each end; and
the second interlocking connector half further comprising a locking groove along each end, configured to interlock with the locking stem to form a rigid interlocking connector.

5. The fishing rod holder system of claim 4, wherein the interlocking connector further comprising:
an interlocking connector thread disposed along an interior surface and configured to engage the threaded tabs, wherein one interlocking connector is fastened to the threaded tabs at each end of the rod holder, and tightening each interlocking connector draws the threaded tabs tighter around the handle of the fishing rod, securing the rod holder in place.

6. The fishing rod holder system of claim 1, further comprising a raised ridge encircling the adjustment slot along an exterior surface of the stake half.

7. The fishing rod holder system of claim 6, wherein the raised ridge includes a flat ridge crest, and tightening the knob against the flat ridge crest provides a flat surface for the knob to engage and distribute pressure when tightening the stake within the stake retaining compartment, preventing motion of the stake during use or storage.

8. The fishing rod holder system of claim 1, wherein the stake includes a pointed end to facilitate penetration into the ground during use.

9. A fishing rod holder system comprising:
a rod holder including a stake half, the stake half having one or more aligned pairs of grip clamp slots proximate to perimeter edges of the stake half, the stake half comprising a stake retaining compartment along an interior surface and an adjustment slot that runs along the length of the stake half parallel to the fishing rod;
a grip collar having a grip collar slot that runs along the length of the grip collar allowing the grip collar to be slide around the handle of the fishing rod;
one or more grip clamps, wherein the grip collar is flexible and wraps around a handle of a fishing rod in a self-contouring manner, the rod holder attaches around the grip collar, and the one or more grip clamps pass through the aligned grip clamp slots, securing the rod holder to the handle of the fishing rod;
a stake having a stake attachment hole, the stake configured to fit within the stake retaining compartment, allowing the stake to be retracted for storage into and extended for use from the stake retaining compartment in a slidable manner; and
a knob configured to pass through the adjustment slot and thread into the stake attachment hole, wherein loosening the knob allows the stake to slide in and out of the stake retaining compartment, and tightening the knob secures the stake in place for use or storage.

10. The fishing rod holder system of claim 9, wherein the rod holder further comprising a grip pad having:
a front grip pad surface; and
a back grip pad surface, wherein the grip pad is positioned between the stake half and the grip collar.

11. The fishing rod holder system of claim 10, wherein the front grip pad surface further comprising:
a grip pad perimeter rib proximate to each edge; and
one or more grip pad inner ribs positioned between the grip pad perimeter ribs.

12. The fishing rod holder system of claim 10, wherein the back grip pad surface further comprising one or more grip pad notches along perimeter edges, the stake half further comprising:
one or more pad notch tabs disposed along an interior surface of the stake half and configured to engage the grip pad notches to prevent slippage between the grip collar and the stake half.

13. The fishing rod holder system of claim 10, wherein the stake half further comprising grip pad positioning tabs disposed along an interior surface and positioned to abut edges of the grip pad to prevent rotational movement.

14. The fishing rod holder system of claim 9, further comprising a raised ridge encircling the adjustment slot along an exterior surface of the stake half.

15. The fishing rod holder system of claim 9, wherein the raised ridge includes a flat ridge crest, and tightening the knob against the flat ridge crest provides a flat surface for the knob to engage and distribute pressure when tightening the stake within the stake retaining compartment, preventing motion of the stake during use or storage.

16. The fishing rod holder system of claim 9, wherein the stake includes a pointed end to facilitate penetration into the ground during use.

17. A fishing rod holder system comprising:
a rod holder including a stake half, a support half, and more than one threaded tab with a gap therebetween at each end of the rod holder, the stake half comprising a stake retaining compartment along an interior surface;
a stake having a stake slot running along a portion of the stake retaining compartment, the stake configured to slide in and out of the stake retaining compartment in a slidable manner without detachment;
a rib pad positioned between the stake and the rod holder, the rib pad comprising:
a plurality of pressure ribs on a front side configured to flexibly contour to and grip a handle of a fishing rod; and
a rib push ridge along a back side; and
an interlocking connector comprising a first interlocking connector half, a second interlocking connector half configured to interlock with the first half, and an interlocking connector thread disposed along an interior surface, the interlocking connector configured to engage the threaded tabs to compress the rib pad against the handle of the fishing rod by applying a force along the rib push ridge, securing the rod holder to the handle of the fishing rod.

18. The fishing rod holder system of claim 17, further comprising:
a pressure pad pusher including ripple ridges on one side and a push ridge on the other side, the ripple ridges are configured to engage the rib push ridge.

19. The fishing rod holder system of claim 18, further comprising:
a locking tray that is contoured to receive the pressure pad pusher, the locking tray including locking notches configured to interconnect with locking tabs disposed along an interior surface of the stake half.

20. The fishing rod holder system of claim 17, further comprising:
an interlocking connector that is curvilinear in shape, the interlocking connector comprising:
a first interlocking connector half; and
a second interlocking connector half configured to interlock with the first interlocking connector half.
